(19) United States
(12) Patent Application Publication
(10) Pub. No.: US 2007/0137504 A1
(43) Pub. Date: Jun. 21, 2007

(54) Salad spinner

(75) Inventors: Yiu Chung Wan, Tsuen Wan (HK); Lance Logan Hood, Seattle, WA (US)

Correspondence Address: LEYDIG VOIT & MAYER, LTD, 700 THIRTEENTH ST. NW, SUITE 300, WASHINGTON, DC, 20005-3960, US

(73) Assignee: Kwok Kuen SO, Kwun Tong (HK)

(21) Appl. No.: 11/305,351

(22) Filed: Dec. 19, 2005

(51) Int. Cl. A47J 43/14

(52) U.S. Cl. 99/495

(57) ABSTRACT

A salad spinner has a housing with a lid, a rotatable basket, and a drive mechanism in the lid for rotating the basket to spin water off salad in the basket. The drive mechanism has a manual actuator and a gear train for transmitting drive from the actuator to rotate the basket. The actuator lies on an outer surface of the lid and is movable along the outer surface in opposite directions between first and second positions to rotate the basket in a single direction. A ratchet assembly in driving engagement with the gear train enables transmission of rotational drive only in the single direction. A braking mechanism is included for braking spinning of the basket, and has a manual operator and two braking shoes for movement by the operator to brake spinning of the basket by friction.

### BACKGROUND OF INVENTION

Salad spinners are popular in kitchens for spinning off water from salad, vegetable or the like quickly. Most of them are hand operated. A typical construction includes a housing having a lid, a basket supported in the housing for rotation, and a drive mechanism for rotating the basket to spin off water from salad in the basket. The drive mechanism usually incorporates a handle on a crank for turning by a user.

Such salad spinners often require the use of both hands by a user. Although rotation of the basket can be speeded up by adopting a gear train of a higher gear ratio, turning of the handle can be stiff.

The invention seeks to obviate or at least alleviate at least such problems or shortcoming by providing a new or otherwise improved salad spinner.

### SUMMARY OF THE INVENTION

According to a first aspect of the invention, there is provided a salad spinner comprising a housing having a lid, a basket supported in the housing for rotation about an axis of rotation, and a drive mechanism supported by the lid for rotating the basket to spin off water from salad in the basket. The drive mechanism comprises a manually operable actuator and a drive transmission system provided between the actuator and the basket to transmit drive from the actuator to rotate the basket. The actuator lies on an outer surface of the lid and is movable along the lid surface in opposite directions between first and second positions to rotate the basket in one single direction.

Preferably, the lid surface extends transversely of the axis of rotation.

More preferably, the lid surface extends at substantially right angles to the axis of rotation.

It is preferred that the actuator is resiliently biased towards the first position by a spring for self return to the first position upon release.

Advantageously, the lid includes an abutment for providing a support to a part of a user's hand while said hand operates the actuator, thereby facilitating one hand operation upon the actuator.

More advantageously, the abutment is raised from the lid surface.

More advantageously, the abutment is located within the periphery of the lid surface.

In a preferred arrangement, the actuator is supported for pivotal movement in opposite directions between the first and second positions.

More preferably, the actuator is elongate and is pivotable about one end thereof, the end being in drive engagement with the drive transmission system.

In another preferred arrangement, the actuator is supported for linear movement in opposite directions between the first and second positions.

More preferably, the actuator includes a rack in drive engagement with the drive transmission system.

In a specific construction, the drive transmission system comprises a train of gears.

Preferably, the basket has a lid engageable by the drive mechanism for rotation thereby.

In a preferred embodiment, the drive mechanism includes a ratchet assembly in drive engagement with the drive transmission system to enable transmission of rotational drive only in said one single direction from the actuator to the basket upon movement of the actuator from the first to the second position.

More preferably, the ratchet assembly is provided between the drive transmission system and the basket.

More preferably, the ratchet assembly comprises a ratchet member and at least one pawl co-operable therewith, which are associated with the basket and a trailing end member of the drive transmission system respectively.

Further more preferably, the ratchet member has a circular arrangement of inclined teeth surrounding said at least one pawl for engagement thereby to transmit drive.

Yet further more preferably, said at least one pawl is hinged for free pivotal movement.

It is further preferred that the ratchet assembly includes at least two said pawls arranged symmetrically about an axis of rotation of the ratchet member.

It is yet further preferred that the ratchet assembly includes a carrier having opposite parts at each of which one said pawl is hinged.

It is still yet further preferred that the trailing end member of the drive transmission system includes the carrier.

Preferably, the basket has a lid engageable by the ratchet assembly for rotation thereby.

In a preferred embodiment, the salad spinner includes a braking mechanism for braking the basket, which comprises a manual operator and at least one braking member for movement by the operator to brake the basket.

More preferably, the braking mechanism is housed inside the lid, with the operator exposed on the lid.

More preferably, the operator lies on an outer surface of the lid and is movable along the lid surface.

More preferably, said at least one braking member is resiliently biased by a spring into an inoperative position and is movable by the operator against the action of the spring to an operative position to brake the basket.

More preferably, the drive mechanism includes a drive member for coupling with the basket to rotate the basket, with which drive member said at least one braking member is engageable to brake the basket.

Further more preferably, the drive mechanism includes a ratchet assembly in drive engagement with the drive transmission system to enable transmission of rotational drive only in said one single direction from the actuator to the basket upon movement of the actuator from the first to the second position, the ratchet assembly including the drive member.

Yet further more preferably, the ratchet assembly comprises a ratchet member and at least one pawl co-operable therewith, which are associated with the basket and a trailing end member of the drive transmission system respectively, the ratchet member being the drive member.

Yet further more preferably, the ratchet member has a circular periphery upon which said at least one braking member is engageable to brake the basket.

Still yet further more preferably, the braking mechanism includes two said at least one braking members disposed on opposite sides of the ratchet member.

Preferably, the basket has a lid engageable by the drive member for rotation thereby.

According to a second aspect of the invention, there is provided a salad spinner comprising a housing having a lid, a basket supported in the housing for rotation about an axis of rotation, and a drive mechanism for rotating the basket to spin off water from salad in the basket. The drive mechanism comprises a manually operable actuator, a drive transmission system provided between the actuator and the basket to transmit drive from the actuator to rotate the basket, and a ratchet assembly in drive engagement with the drive transmission system to enable transmission of rotational drive only in one single direction from the actuator to the basket.

Preferably, the actuator is movable in opposite directions between first and second positions to rotate the basket in said one single direction, and the ratchet assembly enables transmission of rotational drive only in said one single direction upon movement of the actuator from the first to the second position.

More preferably, the ratchet assembly is provided between the drive transmission system and the basket.

More preferably, the ratchet assembly comprises a ratchet member and at least one pawl co-operable therewith, which are associated with the basket and a trailing end member of the drive transmission system respectively.

Further more preferably, the ratchet member has a circular arrangement of inclined teeth surrounding said at least one pawl for engagement thereby to transmit drive.

Yet further more preferably, said at least one pawl is hinged for free pivotal movement.

Yet further more preferably, the ratchet assembly includes at least two said pawls arranged symmetrically about an axis of rotation of the ratchet member.

Yet further more preferably, the ratchet assembly includes a carrier having opposite parts at each of which one said pawl is hinged.

Still yet further more preferably, the trailing end member of the drive transmission system includes the carrier.

Preferably, the basket has a lid engageable by the ratchet assembly for rotation thereby.

According to a third aspect of the invention, there is provided a salad spinner comprising a housing having a lid, a basket supported in the housing for rotation about an axis of rotation, and a drive mechanism for rotating the basket to spin off water from salad in the basket. The drive mechanism comprises a manually operable actuator, a drive transmission system provided between the actuator and the basket to transmit drive from the actuator to rotate the basket, and a braking mechanism for braking the basket. The braking mechanism comprises a manual operator and at least one braking member for movement by the operator to brake the basket by friction.

Preferably, the braking mechanism is housed inside the lid, with the operator exposed on the lid.

Preferably, the operator lies on an outer surface of the lid and is movable along the lid surface.

Preferably, said at least one braking member is resiliently biased by a spring into an inoperative position and is movable by the operator against the action of the spring to an operative position to brake the basket.

Preferably, the drive mechanism includes a drive member for coupling with the basket to rotate the basket, with which drive member said at least one braking member is engageable to brake the basket.

More preferably, the drive mechanism includes a ratchet assembly in drive engagement with the drive transmission system to enable transmission of rotational drive only in one single direction from the actuator to the basket, the ratchet assembly including the drive member.

Further more preferably, the ratchet assembly comprises a ratchet member and at least one pawl co-operable therewith, which are associated with the basket and a trailing end member of the drive transmission system respectively, the ratchet member being, the drive member.

Yet further more preferably, the ratchet member has a circular periphery upon which said at least one braking member is engageable to brake the basket.

Still yet further more preferably, the braking mechanism includes two said at least one braking members disposed on opposite sides of the ratchet member.

In a preferred embodiment, the actuator and the operator are implemented by separate devices.

In another preferred embodiment, the actuator and the operator are implemented by a unitary device movable in one direction to rotate the basket and in the opposite direction to brake the basket.

Preferably, the basket has a lid engageable by the drive member for rotation thereby.

### BRIEF DESCRIPTION OF DRAWINGS

The invention will now be more particularly described, by way of example only, with reference to the accompanying drawings, in which:

FIG. 1 is a top perspective view of a first embodiment of a salad spinner in accordance with the invention;

FIG. 2 is a top perspective view corresponding to FIG. 1, showing the salad spinner being operated by a hand;

FIG. 3 is a top plan view of the salad spinner of FIG. 1;

FIG. 4 is a cross-sectional side view of the salad spinner of FIG. 3, taken along line IV-IV;

FIGS. 5A to 5C are fragmentary internal perspective views of part of the salad spinner of FIG. 1;

FIG. 6 is an exploded top perspective view of the salad spinner of FIG. 1;

FIG. 7 is an exploded top perspective view of a drive mechanism of the salad spinner of FIG. 6;

FIG. 8 is a top perspective view of the drive mechanism of FIG. 7;

FIG. 9 is a fragmentary top perspective view of part of the drive mechanism of FIG. 8;

FIGS. 10A and 10B are top plan views showing the operation of the drive mechanism of FIG. 8;

FIGS. 11A and 11B are exploded and assembled top perspective views of a ratchet assembly of the salad spinner of FIG. 6;

FIGS. 12A and 12B are top plan views of the ratchet assembly of FIG. 11B, showing its operation in opposite directions;

FIG. 13 is a top perspective view corresponding to FIG. 2, showing a hand operating a braking mechanism of the salad spinner;

FIGS. 14 and 14A are fragmentary top plan views of the braking mechanism of FIG. 13;

FIGS. 15 and 15A are fragmentary top plan views corresponding to FIGS. 14 and 14A, showing the braking mechanism in action;

FIG. 16 is a top perspective view of a second embodiment of a salad spinner in accordance with the invention;

FIG. 17 is a top perspective view corresponding to FIG. 16, showing parts of the salad spinner separated;

FIGS. 18A and 18B are top plan and perspective views of the salad spinner of FIG. 16, showing it being operated by a hand;

FIG. 19 is a top plan view of the salad spinner of FIG. 16;

FIG. 20 is a cross-sectional side view of the salad spinner of FIG. 19, taken along line XX-XX;

FIG. 21 is a partially exploded bottom perspective view of the salad spinner of FIG. 16;

FIG. 22 is an exploded top perspective view of the salad spinner of FIG. 16;

FIGS. 23A, 23B and 23C are top perspective views of a drive mechanism of the salad spinner of FIG. 16;

FIGS. 24A, 24B and 24C are internal top views showing the operation of the drive mechanism of FIGS. 23A, 23B and 23C;

FIGS. 25A and 25B are top perspective views of the salad spinner of FIG. 16, showing a hand operating a braking mechanism thereof;

FIG. 26 is a top perspective view of the braking mechanism of FIGS. 25A and 25B; and

FIGS. 26A and 26B are top plan views of the braking mechanism of FIG. 26, showing how it operates.

### DETAILED DESCRIPTION OF PREFERRED EMBODIMENTS

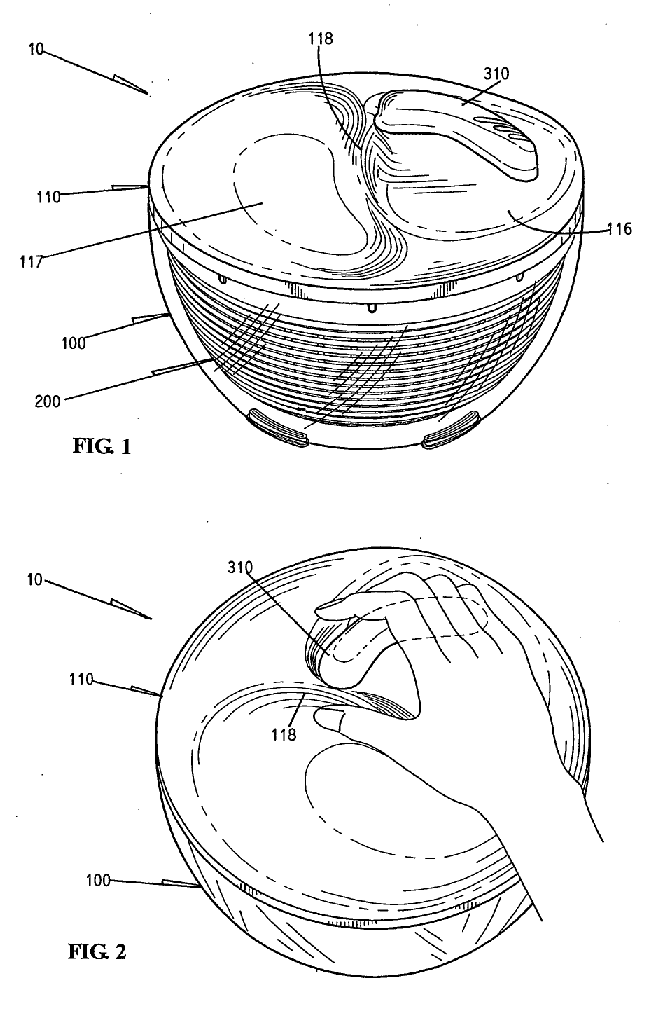

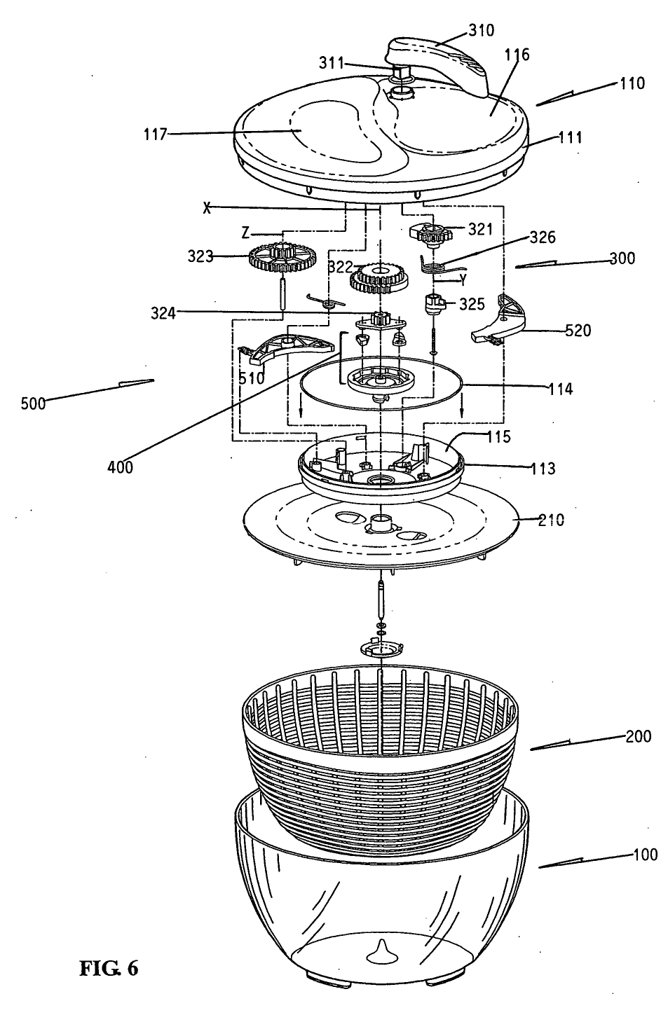

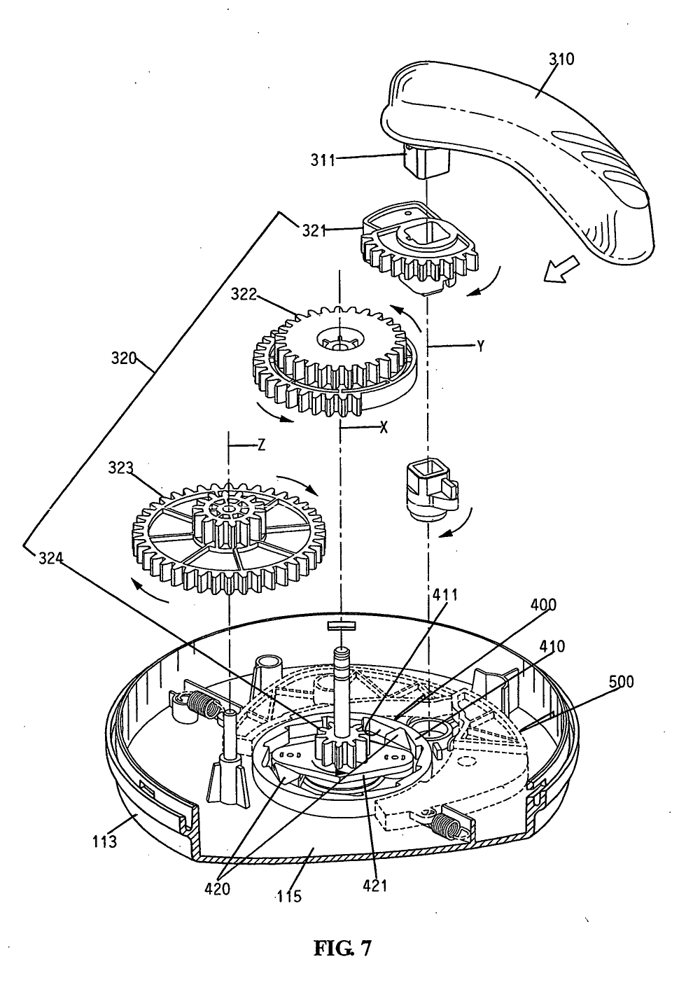

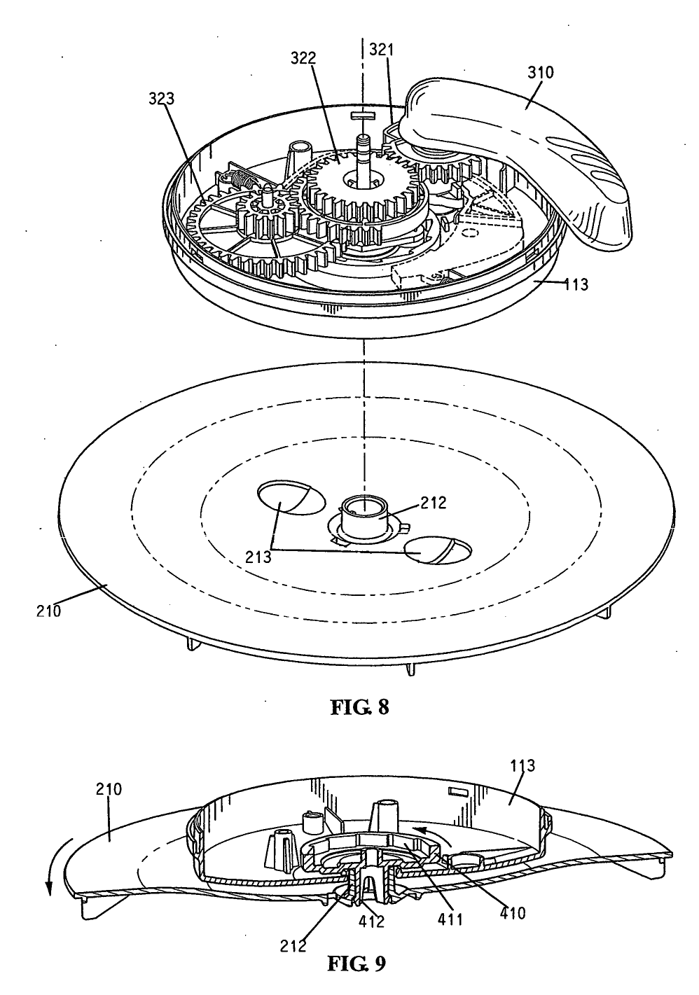

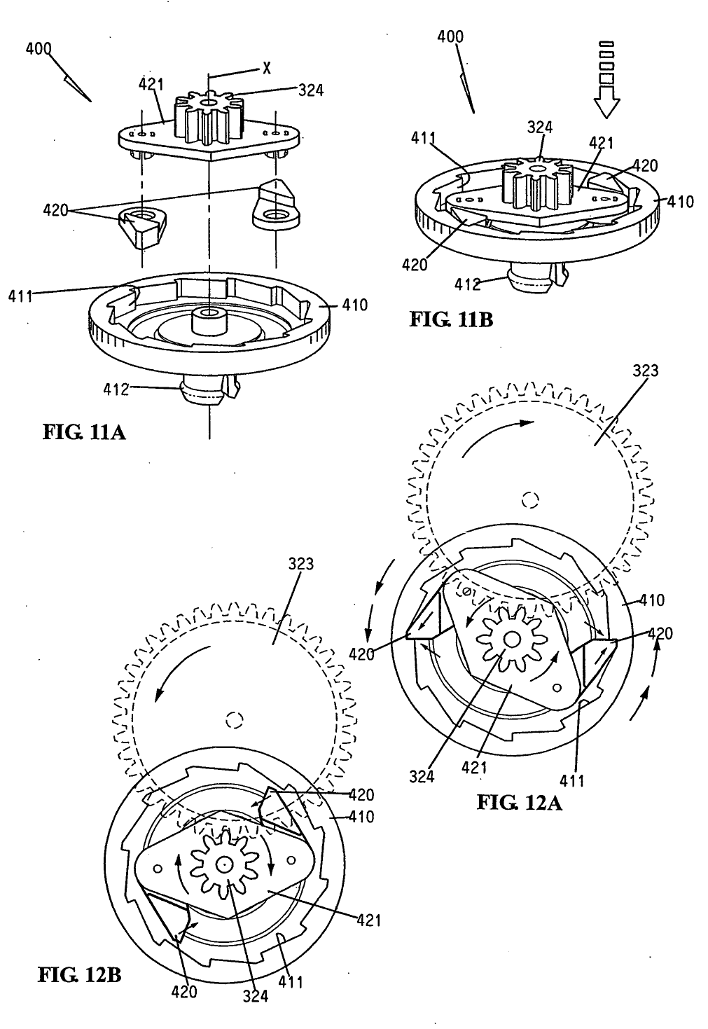

Referring initially to FIGS. 1 to 15A of the drawings, there is shown a first salad spinner 10 embodying the invention, which comprises a round bowl 100 having a circular top lid 110, a round basket 200 contained in the bowl 100 and supported for rotation about a vertical central axis X, and a drive mechanism 300 supported by the lid 110 for rotating the basket 200 so as to spin off water from salad contained in the basket 200.

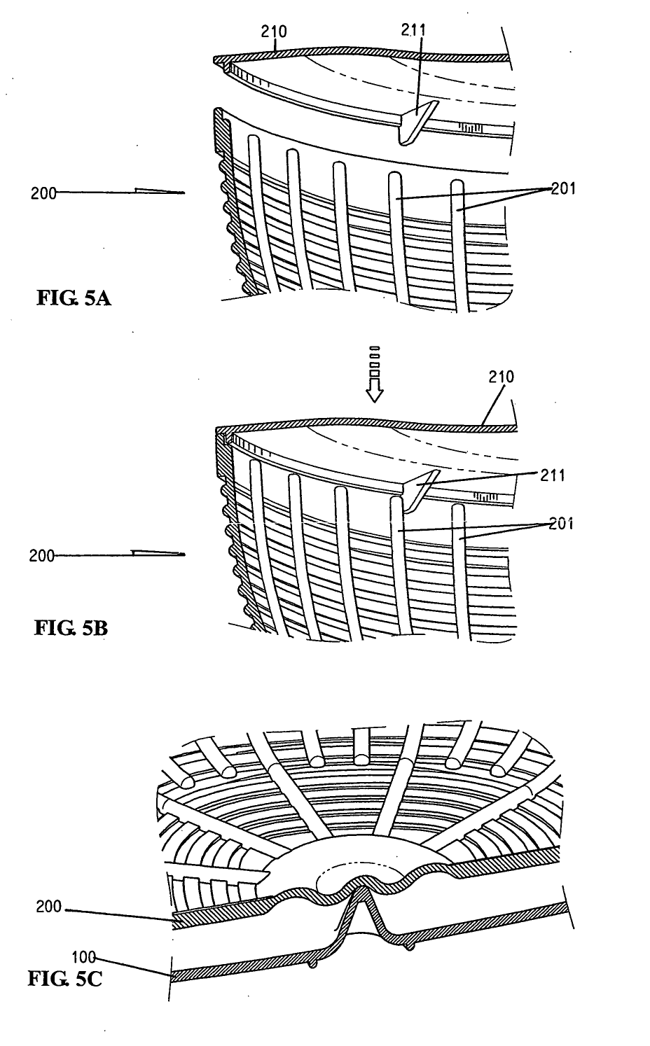

The basket 200 may be closed by its own circular lid 210, and it includes an array of longitudinally ribs 201 on its inner surface. The lid 210 has eight depending lugs 211 along its perimeter for laterally engaging upper ends of the basket ribs 201 (see FIGS. 5A and 5B) such that when the basket 200 is closed it can be rotated by the lid 210.

The basket 200 with lid 210 is slightly smaller than the interior of the bowl 100 with lid 110 to fit loosely therein. The bottom of the basket 200 has a dented centre for engaging upon an upwardly pointed centre of the bowl 100, thereby the basket 200 is centrally located at the bottom. The lid 210 has an upstanding cylindrical collar 212 at its centre, for coupling with the drive mechanism 300 for rotation thereby. A pair of holes 213 on opposite sides of the collar 212 facilitates holding of the lid 210 by a user.

The bowl lid 110 has a horizontal body 111 which is hollow and is open on its lower side and includes an integral short cylindrical collar 112 depending from a broad central region thereof. As part of the lid body 111, an inverted circular base cap 113 closes from below upon the collar 112 via a seal ring 114 to define an internal central cavity 115 of the lid 110, within which there are installed the drive mechanism 300 and a braking mechanism 500.

The drive mechanism 300 comprises a manually operable actuator in the form of a horizontal lever 310 and a gear train 320 provided between the lever 310 and the basket 200 via a ratchet assembly 400 as part of the mechanism 300. The gear train 320 acts as a speed increaser, having a gear ratio of about 10.3 to 1 (output to input). It is formed by a series of four gears 321 to 324 supported for rotation about vertical axes Y, X, Z and X respectively. The leading gear 321 has a square socket engaged by a depending square drive 311 at one end of the lever 310, about which the lever 310 is pivotable about axis Y in opposite directions by a user. The trailing gear 324 is integrated co-axially with a horizontal crossbar 421 of the ratchet assembly 400.

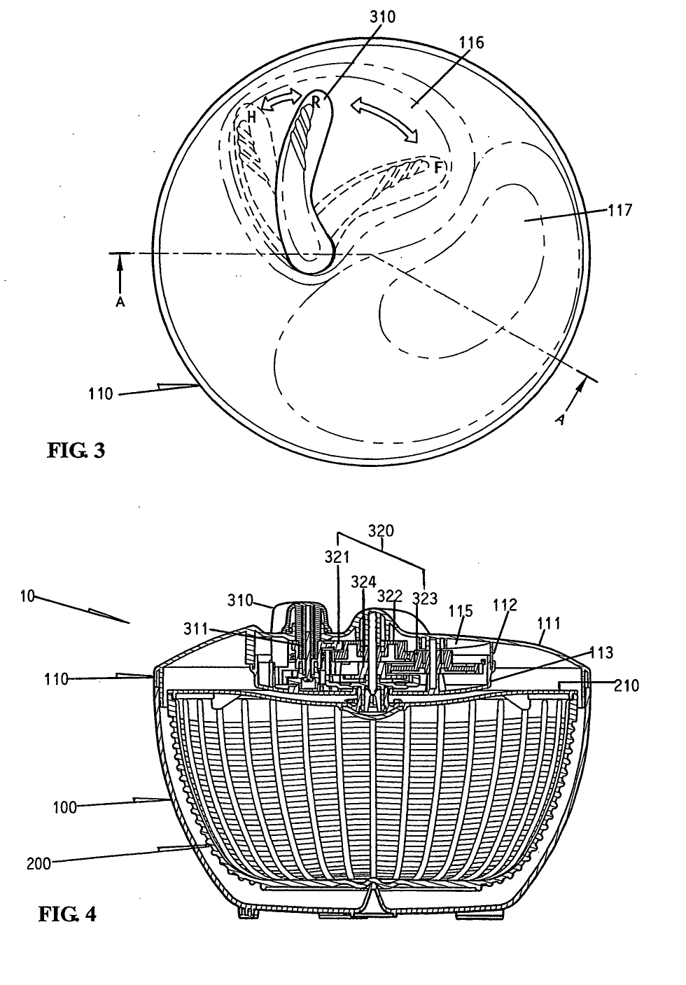

The leading gear 321 is co-axially coupled with a rotary cam 325 for simultaneous turning, together being resiliently biased by an elbow spring 326 to turn in the anti-clockwise direction. Suitable abutments are in place, for example as provided by parts of lid body 111 inside the cavity 115, to limit turning of the leading gear 321 to within an angle of approximately 90°, and hence pivoting of the lever 310 that is attached to the gear 321. In general, the arrangement is such that the lever 310 normally extends and stays in a specific rest angular position R (FIG. 3).

The upper surface of the body 111 of the bowl lid 110 is contoured to form two generally depressed level regions 116 and 117 separated by a ridge 118, which regions 116 and 117 extend transversely of, or at right angles to, the central axis X of rotation. The lever 310 lies on, or very close to, one region 116 in the rest position R, nearer one side of the region 116.

In operation, the lever 310 is pivoted by the right hand of a user (FIG. 2) in the clockwise direction through about 90° to the opposite side to a frontmost position F (FIG. 3) and, upon release, it will immediately self-return to the rest position R under the action of the spring 326. The opposite side of the ridge 118, facing the other flat region 117, provides an abutment support for the user's thumb to bear such that the user can conveniently find support to pull or squeeze the lever 310 close. One hand operation is facilitated by the design of the lever 310 and the lid 110. The ridge 118 is located within the periphery of the lid surface and, more specifically, somewhat in the middle of the lid surface as shown, such that the user's hand can rest entirely on the lid surface for stably holding the salad spinner 10 in position.

The ratchet assembly 400 is located centrally on the lid base cap 113. It is implemented by a horizontal circular ratchet disc 410 having a recessed upper side, within which there is arranged a pair of pawls 420 hinged for free pivotal movement about respective vertical axes through opposite ends of the crossbar 421. The crossbar 421 and the pawls 420 carried thereby are arranged symmetrically about the central axis X for free rotation, and so is the ratchet disc 410. The ratchet disc 410 is formed with a circular arrangement of inclined teeth 411 which extend around the inner side of disc periphery, surrounding the pawls 420 for ratchet engagement thereby in anti-clockwise direction as shown.

The ratchet disc 410 includes a central tube 412 which extends downwardly through a center hole of the lid base cap 113. The tube 412 has its lower end notched on opposite sides to introduce a certain degree of resilience so that it can be snap-fitted into the collar 212 of the basket lid 210, whereby the lid 210 and hence the basket 200 is coupled with the ratchet disc 410 for rotation by the disc 410 acting as a drive member of the drive mechanism 300.

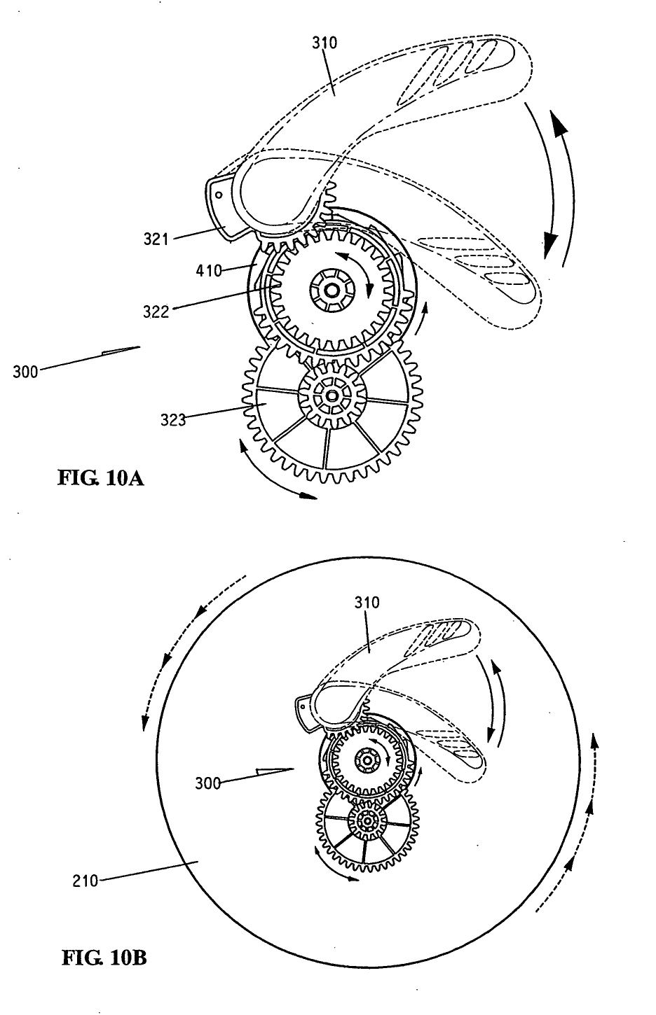

In operation, the lever 310 is pulled and released as described above, and repeatedly to turn the gear train 320 in opposite directions (FIG. 10A). Such bi-directional rotational drive is speeded up and transmitted via the trailing gear 324 to the pawls 420 of the ratchet assembly 400. Through three transitions of gears, the pawls 420 turn in opposite direction compared to the lever 310.

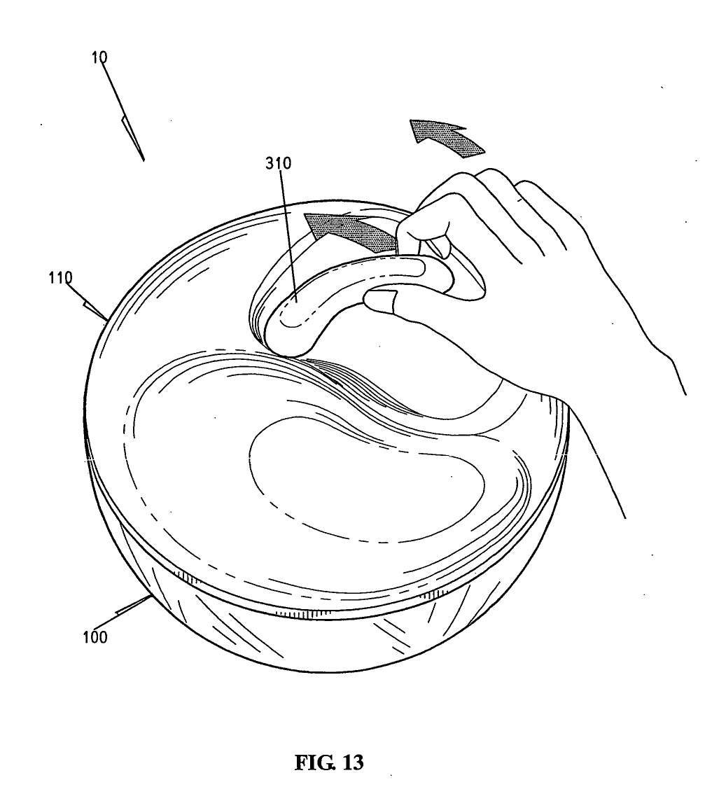

As the lever 310 is pulled to pivot clockwise, the pawls 420 are turned anti-clockwise to thereby engage with or catch the ratchet teeth 411 and hence rotate the ratchet disc 410 anti-clockwise (FIG. 12A). Via the coupling between the ratchet disc 410 and the lid 210, the rotation is thus imparted to the basket 200, which then rotates in the same anti-clockwise direction.

As the lever 310 is subsequently released and pivots back anti-clockwise, the pawls 420 are turned clockwise and thus disengage from the teeth 411 and hence skip or release the ratchet disc 410, which is then permitted to continue to rotate anti-clockwise (FIG. 12B) with the basket 200 and lid 210 under the action of momentum. Continual rotation of the basket 200, etc. is practically unhindered.

By reason of such catch and release actions, the ratchet assembly 400 transmits drive from the gear train 320 to the basket 200 in one single direction (i.e. anti-clockwise) only upon pivoting of the lever 310 from its rest position R to its frontmost position F. Such transmission repeats for as long as the lever 310 is swayed. Although the rotational drive is transmitted and applied to the basket 200 only intermittently, each time the drive is applied the basket 200 gains speed and accelerates, and the basket 200 rotates freely through successive drives. The basket 200 may reach a maximum speed of about 800 rpm after say five to six strokes if the lever 310 is pivoted rapidly and frequently enough.

To stop the basket 200 swiftly, the salad spinner 10 includes a braking mechanism 500 which comprises a pair of braking shoes 510 and 520 arranged for pivotal movement by the lever 310 via the rotary cam 325 when the lever 310 is pivoted or pushed anti-clockwise from its rest position R to a hindmost position H (FIG. 3). The shoes 510 and 520 are planar and crooked and are housed inside the cavity 115 of the bowl lid 110, on opposite left and right sides of and on the same plane as the ratchet disc 410.

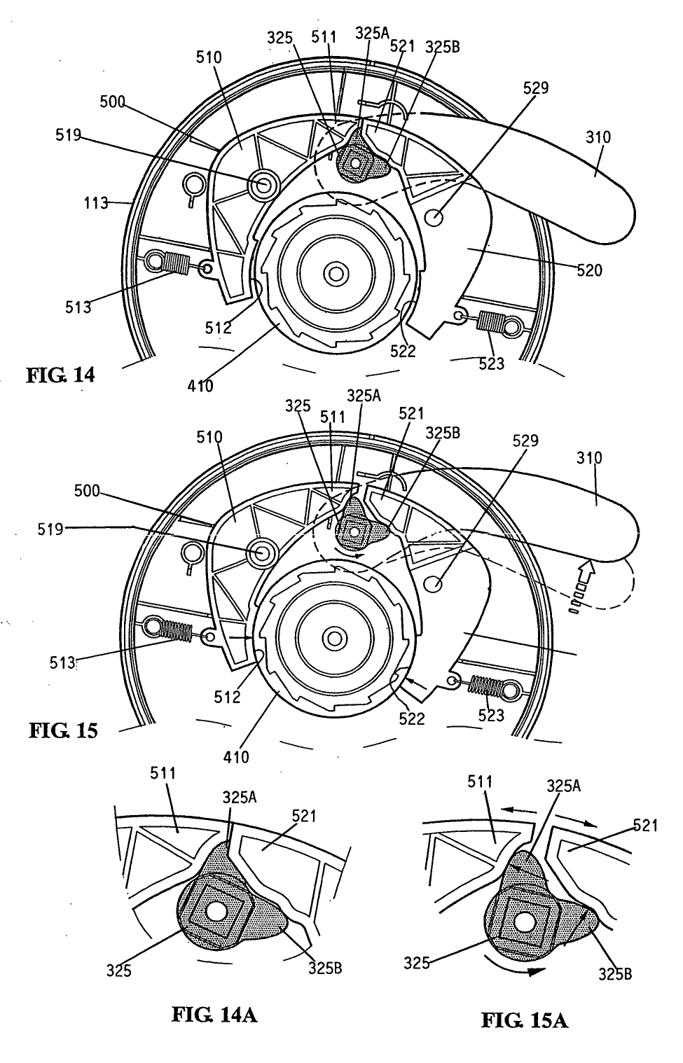

The shoes 510 and 520 are hinged at mid-length about respective hinges 519 and 529 for limited pivotal movement, with their first ends 511 and 521 close to each other and their second ends 512 and 522 flanking the ratchet disc 410. The shoes 510 and 520 are resiliently biased outwardly by separate coil springs 513 and 523 such that their second ends 512 and 522 are spaced narrowly apart from the periphery of the ratchet disc 410 (FIG. 14). In this inoperative position, the shoes' first ends 511 and 521 abut with each other and with respective lobes 325A and 325B of the cam 325.

As the lever 310 is pushed anti-clockwise from its rest position R to a hindmost position H, the cam 325 pivots the shoes 510 and 520 apart by their first ends 511 and 521 counteracting the springs 513 and 523, thereby pressing their second ends 512 and 522 against the periphery of the ratchet disc 410 to brake the disc 410 by friction (FIG. 15) and hence the basket 200.

It is noted that the lever 310 is a unitary device which is designed to perform two functions, i.e. to operate the drive mechanism 300 upon being pulled repeatedly to spin the basket 200 fast and to subsequently apply the braking mechanism 500 upon being pushed to stop the basket 200 quick.

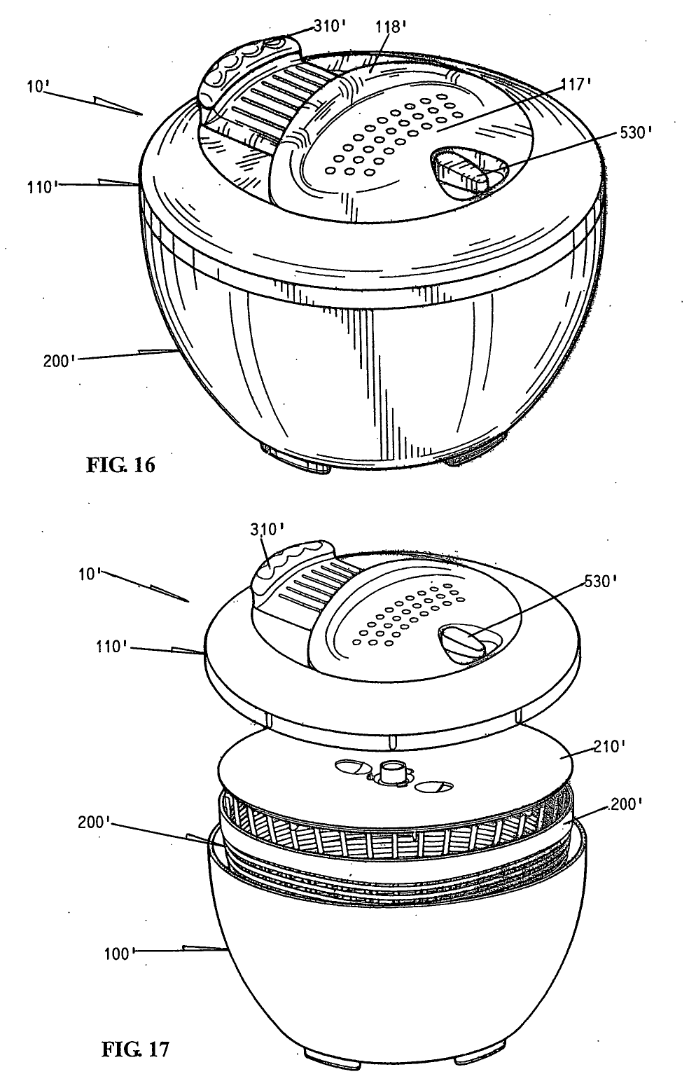

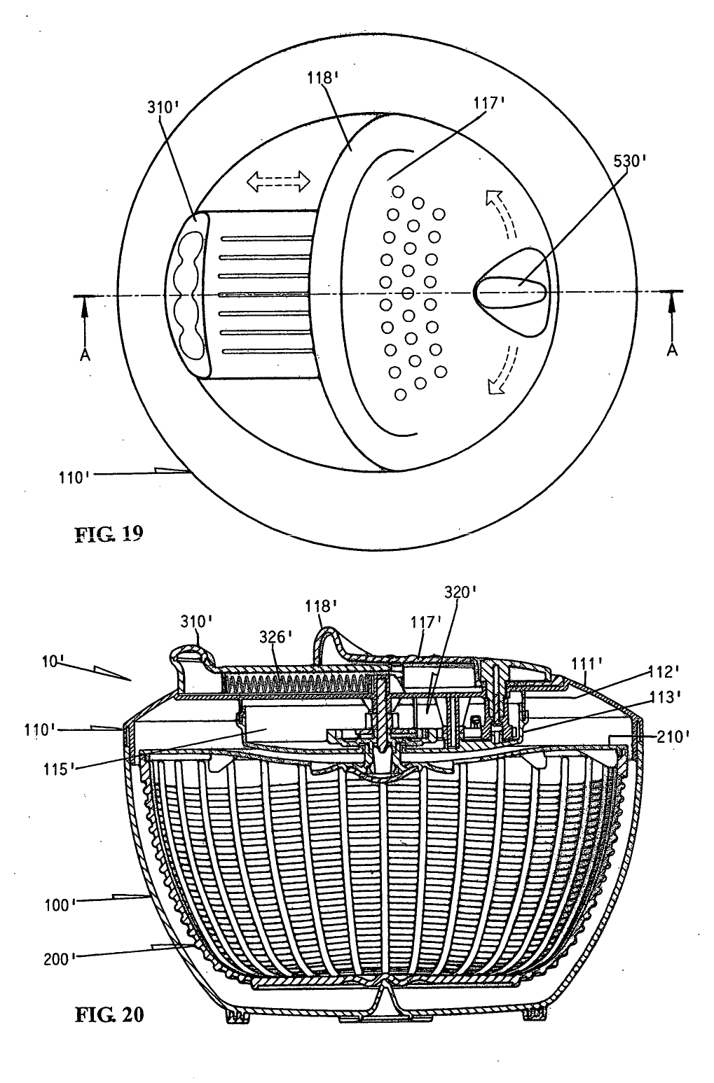

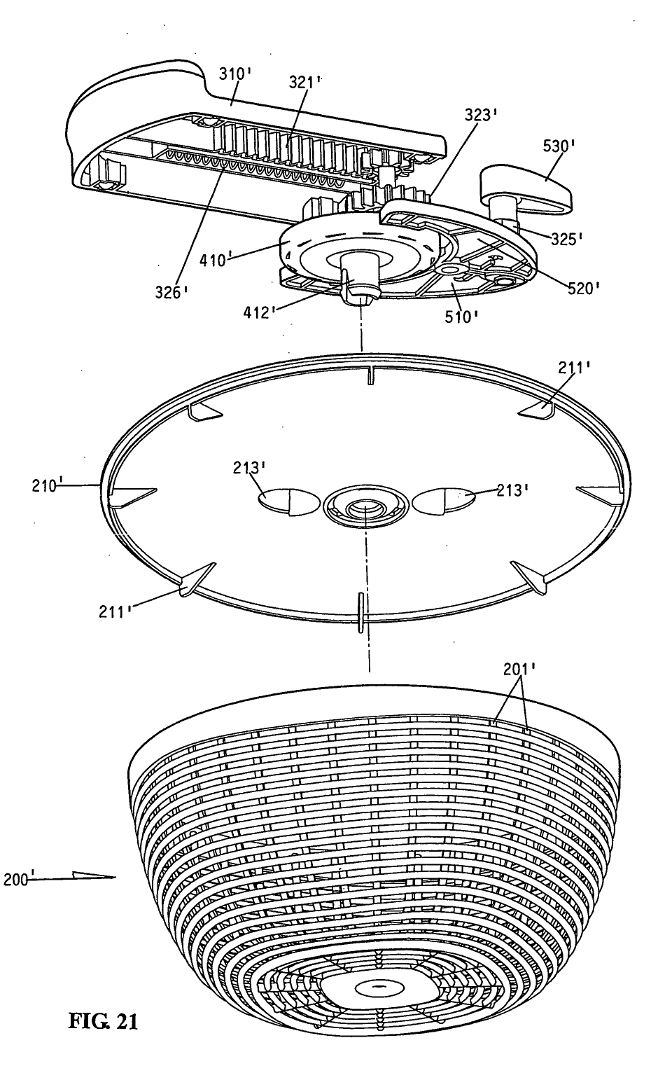

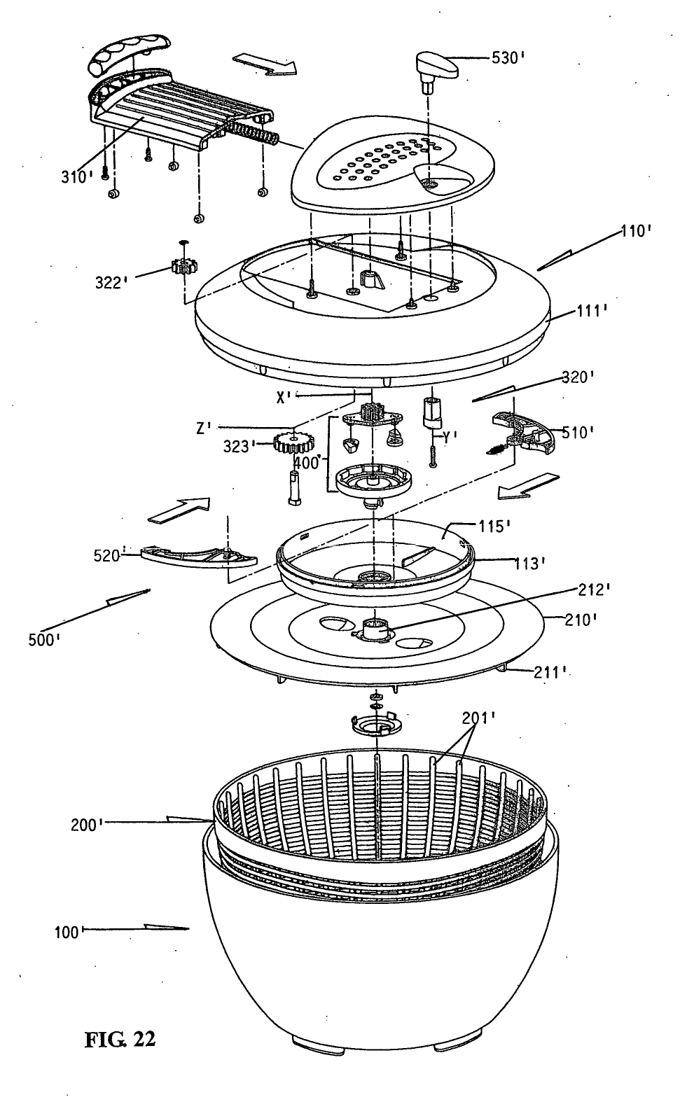

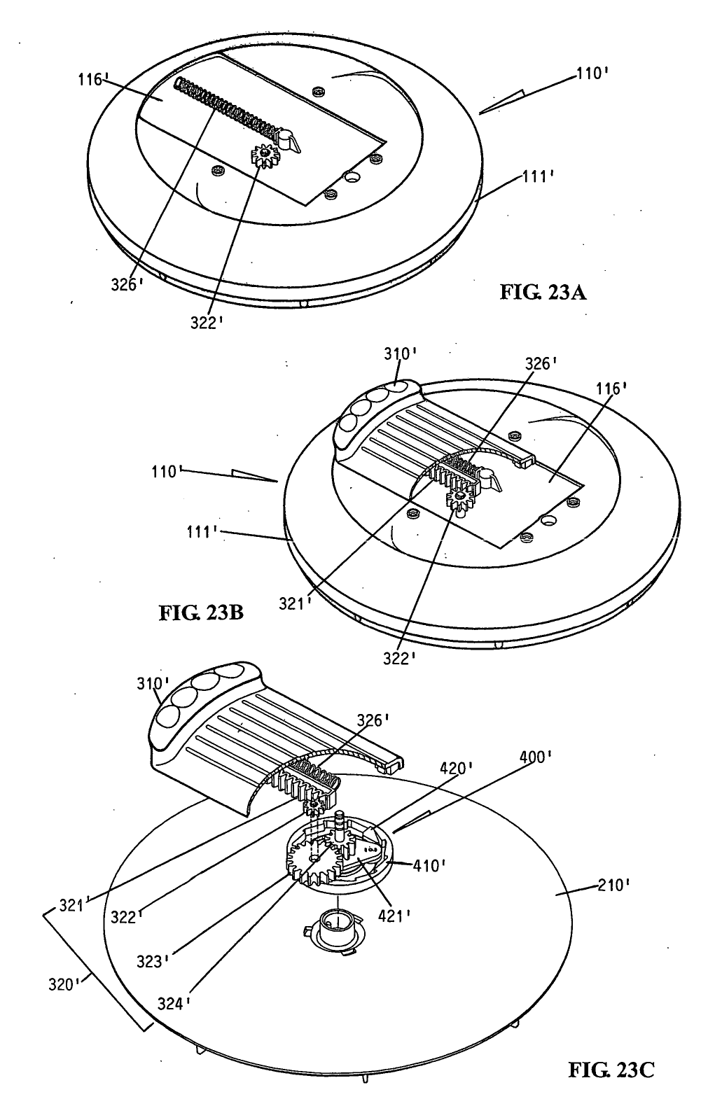

Reference is now made to FIGS. 16 to 26B, which show a second salad spinner 10′ embodying the invention, which has generally the same basic construction and operates in a similar manner as the first salad spinner 10 except as described below, with equivalent parts designated by the same reference numerals suffixed by an apostrophe sign. The major difference lies in the construction and operation of the drive mechanism 300′ and the braking mechanism 500′.

In this embodiment, the drive mechanism 300′ comprises a manually operable actuator in the form of a horizontal slider 310′ and a gear train 320′ provided between the slider 310′ and the basket 200′ via the ratchet assembly 400′ as part of the mechanism 300′.

The upper surface of the body 111′ of the bowl lid 110′ is configured to provide a level linear track 116′ for the slider 310′ and a roof 117′ which encloses an inner end of the track 116′ to form a dock for receiving the slider 310′. The roof 117′ has an uppermost ridge 118′ extending alongside the entrance of the dock.

The slider 310′ lies on, or very close to, the track 116′ and is slidable horizontally therealong in opposite directions between an outer rest position out of the roof 117′ and an inner position into the roof 117′. An internal coil spring 326′ resiliently biases the slider 310′ outwardly towards the rest position.

The gear train 320′ acts as a speed increaser, which is formed by a series of four gears 321′ to 324′ supported for rotation about two vertical axes, with the exception of the leading gear 321′ which is a straight rack. The rack 321′ is an internal integral part of the slider 310′, which extends parallel to the track 116′ and is in mesh with the second gear 322′. The third gear 323′ is rotatable with the second gear 322′ about the same axis, and in mesh with the trailing gear 324′. As in the case of the earlier embodiment, the trailing gear 324′ is integrally co-axially formed with the crossbar 421′ of the ratchet assembly 400′, and the assembly 400′ has the same construction and operates in the same manner as described above.

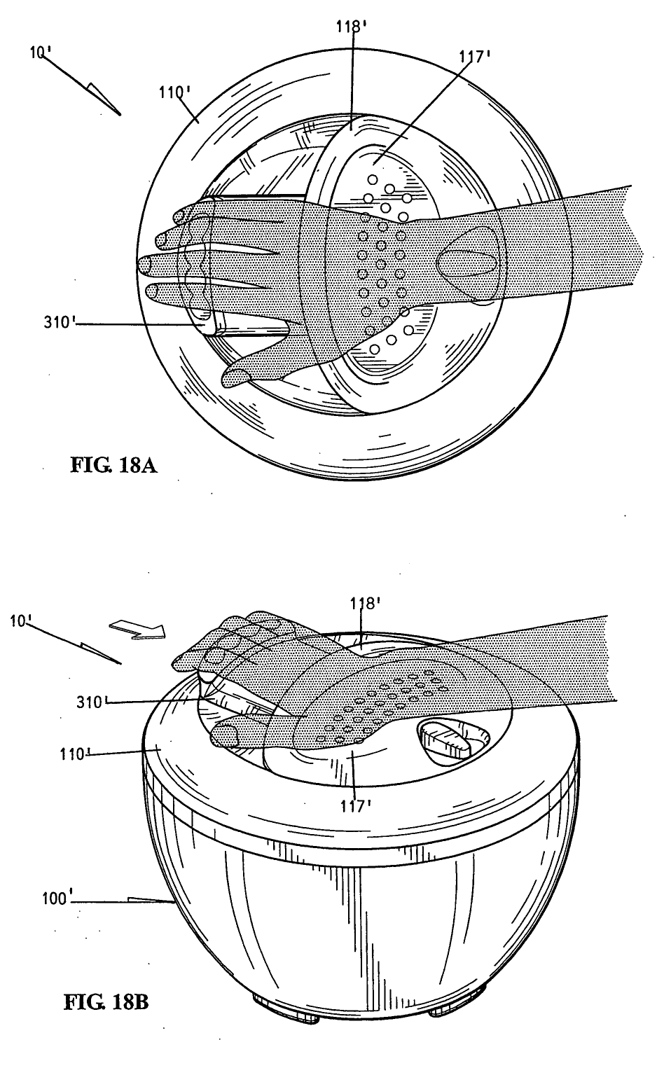

In operation, the slider 310′ is held by one hand, say the right hand, of a user (FIGS. 18A and 18B), with the fingers gripping a raised free end of the slider 310′ and the back of the palm abutting and bearing right behind the ridge 118′ for support to draw the slider 310′ into the roof 117′. Upon release, the slider 310′ will immediately self-return to the outer rest position under the action of the spring 326′.

The ridge 118′ is located within the periphery of the lid surface and, more specifically, somewhat in the middle of the lid surface as shown, such that the user's hand can rest entirely on the lid surface for stably holding the salad spinner 10′ in position. One hand operation is facilitated by the design of the slider 310′ and the lid 110′.

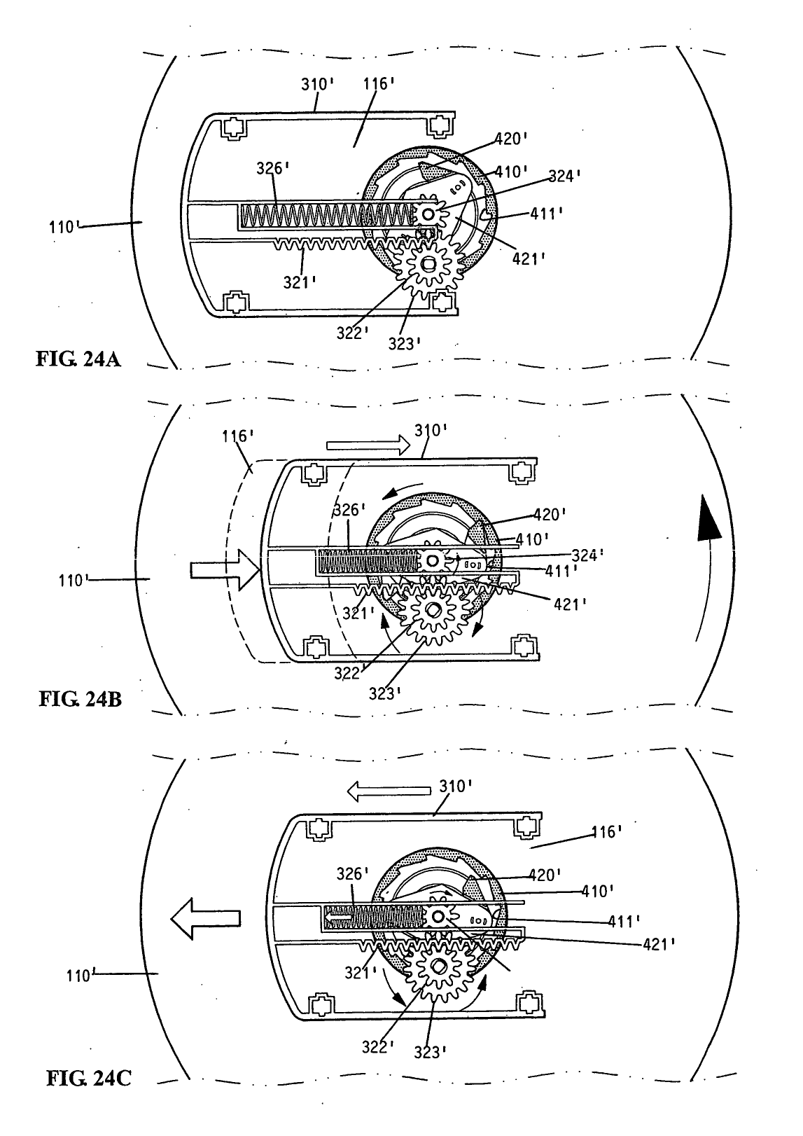

The slider 310′ is pulled and released repeatedly to slide its rack 321′ back-and-forth and hence to turn the other gears 322′ to 324′ in opposite directions (FIGS. 24B and 24C). Such bi-directional rotational, drive is speeded up and transmitted by the gear train 320′ via the trailing gear 324′ to the pawls 420′ of the ratchet assembly 400′.

As the slider 310′ is pulled back, the pawls 420′ are turned anti-clockwise to thereby engage with or catch the ratchet teeth 411′ and hence rotate the ratchet disc 410′ anti-clockwise (FIG. 24B). Via the coupling between the ratchet disc 410′ and the lid 210′, the rotation is thus imparted to the basket 200′, which then rotates in the same anti-clockwise direction.

As the slider 310′ is subsequently released to re-extend outwards, the pawls 420′ are turned clockwise and thus disengage from the teeth 411′ and hence skip or release the ratchet disc 410′, which is then allowed to continue to rotate anti-clockwise (FIG. 24C) with the basket 200′ and lid 210′ under the action of momentum. Continual rotation of the basket 200′, etc. is practically unhindered.

By reason of such catch and release actions, the ratchet assembly 400′ transmits drive from the gear train 320′ to the basket 200′ in one single direction (i.e. anti-clockwise) only upon sliding of the slider 310′ from its outer position to its inner position. Such transmission repeats for as long as the slider 310′ is pulled. Although the rotational drive is transmitted and applied to the basket 200′ only intermittently, each time the drive is applied the basket 200′ gains speed and accelerates, and the basket 200′ rotates freely through successive drives. The basket 200′ may reach a maximum speed of almost 800 rpm after say five to six strokes if the slider 310 is pulled rapidly and frequently enough.

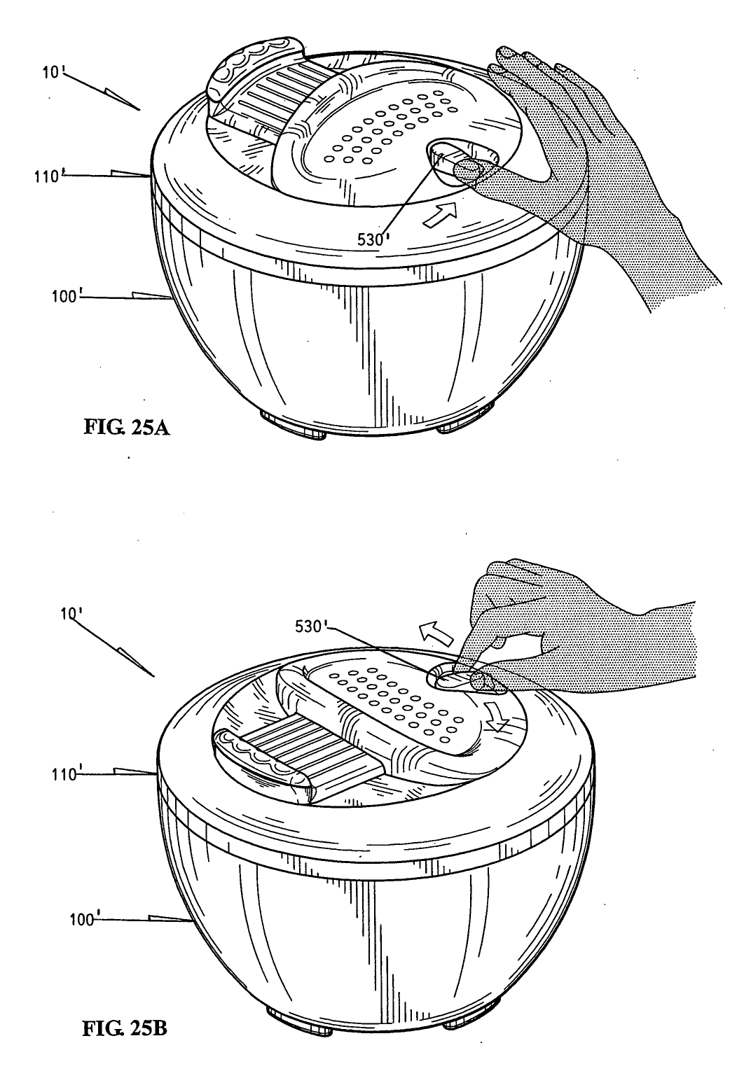

The braking mechanism 500′ has a slightly different construction and is operated by means of an independent operator in the form of a short lever 530′ lying on the bowl lid 110′. The lever 530′ is pivotable about a vertical shaft inside the cavity 115′ of the bowl lid 110′, to which a rotary cam 325′ is attached. Inside the cavity 115′, the braking mechanism 500′ includes a pair of flat horizontal and crooked braking shoes 510′ and 520′ arranged for pivotal movement by the lever 530′ via the rotary cam 325′ upon pivoting of the lever 530′ in either direction (FIGS. 25A and 25B).

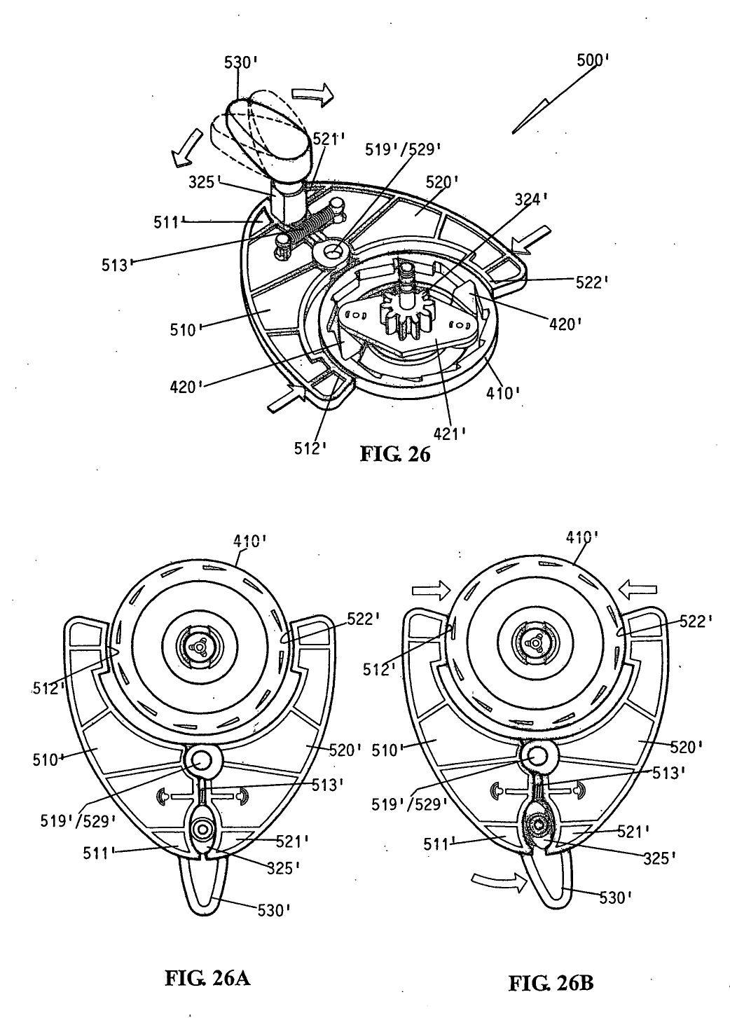

The shoes 510′ and 520′ are hinged at mid-length about a common hinge 519′/529′ for limited pivotal movement, with their first ends 511′ and 521′ flanking the cam 325′ and their second ends 512′ and 522′ flanking the ratchet disc 410′. The first ends 511′ and 521′ are resiliently biased by a coil spring 513′ stretched across them against the cam 325′ such that the second ends 512′ and 522′ are spaced narrowly apart from the periphery of the ratchet disc 410′ (FIG. 26A).

As the lever 530′ is pivoted in either direction, the cam 325′ operatively pivots the shoes 510′ and 520′ apart by their first ends 511′ and 521′ counteracting the spring 513′, whereby their second ends 512′ and 522′ are pressed against the periphery of the ratchet disc 410′ to brake the disc 410′ by friction (FIG. 26B) and hence the basket 200′.

It is envisaged that any other suitable forms of drive transmission system (320/320′) may be employed or included, such as pulleys and belts.

The invention has been given by way of example only, and various other modifications of and/or alterations to the described embodiments may be made by persons skilled in the art without departing from the scope of the invention as specified in the appended claims.

1. A salad spinner comprising:
a housing having a lid;
a basket supported in the housing for rotation about an axis of rotation; and
a drive mechanism supported by the lid for rotating the basket to spin water off salad in the basket, wherein the drive mechanism comprises a manually operable actuator and a drive transmission system located between the actuator and the basket to transmit a driving input applied to the actuator to rotate the basket, the actuator lying on an outer surface of the lid and being movable along the outer surface in opposite directions, between first and second positions, to rotate the basket in a single direction.

2. The salad spinner as claimed in claim 1, wherein the lid surface extends transversely to the axis of rotation.

3. The salad spinner as claimed in claim 2, including a sprint, wherein the lid surface extends at substantially right angles to the axis of rotation.

4. The salad spinner as claimed in claim 1, wherein the actuator is resiliently biased towards the first position by the spring for return to the first position upon release.

5. The salad spinner as claimed in claim 1, wherein the lid includes an abutment for providing support to a part of a user's hand while the hand operates the actuator, thereby facilitating one-handed operation of the actuator.

6. The salad spinner as claimed in claim 5, wherein the abutment is raised from the outer surface.

7. The salad spinner as claimed in claim 5, wherein the abutment is located within a periphery of the outer surface.

8. The salad spinner as claimed in claim 1, wherein the actuator is supported for pivotal movement in opposite directions between the first and second positions.

9. The salad spinner as claimed in claim 8, wherein the actuator is elongate and is pivotable about one end of the actuator, the end engaging the drive transmission system.

10. The salad spinner as claimed in claim 1, wherein the actuator is supported for linear movement in opposite directions between the first and second positions.

11. The salad spinner as claimed in claim 10, wherein the actuator includes a rack engaging the drive transmission system.

12. The salad spinner as claimed in claim 1, wherein the drive transmission system comprises a train of gears.

13. The salad spinner as claimed in claim 1, wherein the basket has a lid engageable by the drive mechanism for rotation of the basket.

14. The salad spinner as claimed in claim 1, wherein the drive mechanism includes a ratchet assembly in driving engagement with the drive transmission system for transmission of rotational drive only in the single direction from the actuator to the basket upon movement of the actuator from the first position to the second position.

15. The salad spinner as claimed in claim 14, wherein the ratchet assembly is located between the drive transmission system and the basket.

16. The salad spinner as claimed in claim 14, wherein the ratchet assembly comprises a ratchet member and at least one pawl co-operable with the ratchet member, which are associated with the basket and a trailing end member of the drive transmission system respectively.

17. The salad spinner as claimed in claim 16, wherein the ratchet member has a circular arrangement of inclined teeth surrounding the at least one pawl for engagement to transmit the driving input.

18. The salad spinner as claimed in claim 17, wherein the at least one pawl is hinged for free pivotal movement.

19. The salad spinner as claimed in claim 17, wherein the ratchet assembly includes at least two pawls arranged symmetrically about an axis of rotation of the ratchet member.

20. The salad spinner as claimed in claim 19, wherein the ratchet assembly includes a carrier having opposite parts, at each of which one of the pawls is hinged.

21. The salad spinner as claimed in claim 20, wherein the drive transmission system includes a trailing end member including the carrier.

22. The salad spinner as claimed in claim 14, wherein the basket has a lid engageable by the ratchet assembly for rotation of the basket.

23. The salad spinner as claimed in claim 1, including a braking mechanism for braking spinning of the basket, the braking mechanism comprising a manual operator and at least one braking member for movement by the operator to brake spinning of the basket.

24. The salad spinner as claimed in claim 23, wherein the braking mechanism is housed inside the lid, and the operator is exposed on the lid.

25. The salad spinner as claimed in claim 23, wherein the operator lies on the outer surface of the lid and is movable along the outer surface.

26. The salad spinner as claimed in claims 23, including a spring, wherein the at least one braking member is resiliently biased by the spring into an inoperative position and is movable by the operator against the spring to an operative position to brake spinning of the basket.

27. The salad spinner as claimed in claim 23, wherein the drive mechanism includes a drive member coupling with the basket to rotate the basket, and engageable with the at least one braking member to brake the basket.

28. The salad spinner as claimed in claim 27, wherein the drive mechanism includes a ratchet assembly engaging the drive transmission system for transmission of rotational drive, only in the single directions, from the actuator to the basket upon movement of the actuator from the first position to the second position, the ratchet assembly including the drive member.

29. The salad spinner as claimed in claim 28, wherein the ratchet assembly comprises a ratchet member and at least one pawl co-operable with the ratchet member, the ratchet member and the at least one pawl being associated with the basket and a trailing end member of the drive transmission system, respectively, the ratchet member being the drive member.

30. The salad spinner as claimed in claim 29, wherein the ratchet member has a circular periphery with which the at least one braking member engages to brake spinning of the basket.

31. The salad spinner as claimed in claim 30, wherein the braking mechanism includes two braking members disposed on opposite sides of the ratchet member.

32. The salad spinner as claimed in claim 27, wherein the basket has a lid engageable by the drive member for rotation of the basket.

33. A salad spinner comprising:
a housing having a lid;
a basket supported in the housing for rotation about an axis of rotation; and
a drive mechanism for rotating the basket to spin water off salad in the basket, wherein the drive mechanism comprises a manually operable actuator, a drive transmission system located between the actuator and the basket to transmit a driving input applied to the actuator to rotate the basket, and a ratchet assembly in driving engagement with the drive transmission system for transmission of rotational drive only in a single direction from the actuator to the basket.

34. The salad spinner as claimed in claim 33, wherein the actuator is movable in opposite directions between first and second positions to rotate the basket in the single direction, and the ratchet assembly enables transmission of rotational drive only in the single direction upon movement of the actuator from the first position to the second position.

35. The salad spinner as claimed in claim 34, wherein the ratchet assembly is located between the drive transmission system and the basket.

36. The salad spinner as claimed in claim 34, wherein the ratchet assembly comprises a ratchet member and at least one pawl co-operable with the ratchet member, the ratchet member and the at least one pawl being associated with the basket and a trailing end member of the drive transmission system, respectively.

37. The salad spinner as claimed in claim 36, wherein the ratchet member includes a circular arrangement of inclined teeth surrounding the at least one pawl for engagement to transmit the driving input.

38. The salad spinner as claimed in claim 37, wherein the at least one pawl is hinged for free pivotal movement.

39. The salad spinner as claimed in claim 37, wherein the ratchet assembly includes at least two pawls arranged symmetrically about an axis of rotation of the ratchet member.

40. The salad spinner as claimed in claim 37, wherein the ratchet assembly includes a carrier having opposite parts at each of which one of the pawls is hinged.

41. The salad spinner as claimed in claim 40, wherein the trailing end member of the drive transmission system includes the carrier.

42. The salad spinner as claimed in claim 33, wherein the basket has a lid engageable by the ratchet assembly for rotation of the basket.

43. A salad spinner comprising:
a housing having a lid;
a basket supported in the housing for rotation about an axis of rotation; and
a drive mechanism for rotating the basket to spin water off salad in the basket, wherein the drive mechanism comprises a manually operable actuator, a drive transmission system located between the actuator and the basket to transmit a driving input applied to the actuator to rotate the basket, and a braking mechanism for braking spinning of the basket, the braking mechanism comprising a manual operator and at least one braking member for movement by the operator to brake spinning of the basket by friction.

44. The salad spinner as claimed in claim 43, wherein the braking mechanism is housed inside the lid, with the operator exposed on the lid.

45. The salad spinner as claimed in claim 43, wherein the operator lies on an outer surface of the lid and is movable along the outer surface.

46. The salad spinner as claimed in claims 43, including a spring, wherein the at least one braking member is resiliently biased by the spring into an inoperative position and is movable by the operator against the spring to an operative position to brake the basket.

47. The salad spinner as claimed in claim 43, wherein the drive mechanism includes a drive member coupling with the basket to rotate the basket, and the at least one braking member is engageable to brake the basket.

48. The salad spinner as claimed in claim 47, wherein the drive mechanism includes a ratchet assembly in driving engagement with the drive transmission system to for transmission of rotational drive only in a single direction from the actuator to the basket, the ratchet assembly including the drive member.

49. The salad spinner as claimed in claim 48, wherein the ratchet assembly comprises a ratchet member and at least one pawl co-operable with the ratchet member, the ratchet member and the at least one pawl being associated with the basket and a trailing end member of the drive transmission system, respectively, the ratchet member being the drive member.

50. The salad spinner as claimed in claim 49, wherein the ratchet member has a circular periphery with which the at least one braking member is engageable to brake spinning of the basket.

51. The salad spinner as claimed in claim 50, wherein the braking mechanism includes two braking members disposed on opposite sides of the ratchet member.

52. The salad spinner as claimed in claim 43, wherein the actuator and the operator are separate devices.

53. The salad spinner as claimed in claim 43, wherein the actuator and the operator are a unitary device movable in a first direction to rotate the basket and in a second direction, opposite the first direction, to brake spinning of the basket.

54. The salad spinner as claimed in claim 47, wherein the basket has a lid engageable by the drive member for rotation of the basket.
